(19) United States
(12) Patent Application Publication
(10) Pub. No.: US 2014/0143382 A1
(43) Pub. Date: May 22, 2014

(54) MEDICAL IMAGE EXCHANGE SYSTEM AND IMAGE RELAY SERVER

(71) Applicant: Techno Project Ltd., Shimane (JP)

(72) Inventors: Hiroshi Yoshioka, Shimane (JP); Eiji Hasegawa, Shimane (JP)

(73) Assignee: Techno Project Ltd., Shimane (JP)

(21) Appl. No.: 14/165,939

(22) Filed: Jan. 28, 2014

Related U.S. Application Data
(63) Continuation of application No. PCT/JP2013/060561, filed on Apr. 5, 2013.

(30) Foreign Application Priority Data
Oct. 1, 2012 (JP) 2012-219836

(51) Int. Cl. H04L 29/08

(52) U.S. Cl. CPC H04L 67/12
USPC 709/217

(57) ABSTRACT

A medical image exchange system connects a transmission system to an image relay server. The medical image exchange system includes a device configured to input a transmission destination of image data and select image data, in response to a request from the in-hospital terminal. The medical image exchange system includes a device configured to generate an image relay form including relay information on the transmission destination and information for identifying the selected image data. The image relay server transmits a request to acquire the image to the transmission system based on the image relay form. The image transmission system acquires the image in response to the acquisition request, and transmits the image to the image relay server.

### CROSS-REFERENCE TO RELATED APPLICATION

This application is based on Japanese Patent Application No. 2012-219836 filed with the Japan Patent Office on Oct. 1, 2012, and PCT International Application NO. PCT/JP2013/60561 filed on Apr. 5, 2013, the entire contents of which are hereby incorporated by reference.

### BACKGROUND

1. Technical Field

The present invention relates to a system and a server that exchange medical image data between a plurality of medical institutions. The present invention particularly relates to a medical image exchange system and an image relay server, which allow a plurality of medical institutions to easily exchange medical image data between them without significantly changing the configurations of their respective image control systems.

2. Related Art

There is a known system serving as a technique for exchanging medical image data between a plurality of medical institutions. In such a system, one medical institution functioned as a medical image center serves as a core to allow a plurality of medical institutions to exchange (transmit/receive or transfer) image data between them (for example, Patent Literature 1). Namely, the system is 1:N data exchange.

### CITATION LIST

### Patent Literature

Patent Literature 1: JP-A-2010-134540

### SUMMARY

A medical image exchange system allows a plurality of medical institutions to exchange medical image data between the medical institutions through an image relay server. The system is configured to communicatably connect the image relay server to one or a plurality of medical image transmission systems used in each of the medical institutions. The medical image transmission system includes: an in-hospital terminal; a medical image display terminal; a transmission destination input device configured to input a transmission destination of medical image data held by the medical image display terminal in response to a request from the in-hospital terminal; a medical image data selection device configured to select any of the medical image data held by the medical image display terminal in response to a request from the in-hospital terminal; and an image relay form generation device configured to generate an image relay form including relay information on the transmission destination input by the transmission destination input device, and image identification information for identifying the medical image data selected by the medical image data selection device. The image relay server includes a transmission device configured to transmit a request to acquire the medical image data to the medical image transmission system based on the image relay form. The medical image transmission system includes: a medical image data acquisition device configured to acquire the medical image data from the medical image display terminal in response to the acquisition request; and a first medical image data transmission device configured to transmit to the image relay server the medical image data acquired by the medical image data acquisition device.

The image relay server further includes: a medical image database medical image data receiving device configured to receive the medical image data and a medical image data storing device configured to store the medical image data received by the medical image data receiving device in the medical image database.

### BRIEF DESCRIPTION OF DRAWINGS

FIG. 1 is a diagram illustrating an outline of an entire configuration of a medical image exchange system according to the embodiment.

FIG. 2 is a diagram illustrating a data structure of an image relay form.

FIG. 3 is a sequence illustrating a medical image data transmission process to be executed between a medical image transmission system 100a and an image relay server 200.

FIG. 4 is a sequence illustrating a medical image data transmission process to be executed between a medical image transmission system 100b and the image relay server 200.

FIG. 5 is a sequence illustrating a medical image data receiving process to be executed between the image relay server 200 and a medical image receiving system 100c.

FIG. 6 is a sequence illustrating a medical image data receiving process to be executed between the image relay server 200 and a medical image receiving system 100d.

FIG. 7 is a sequence illustrating a medical image data receiving process to be executed between the image relay server 200 and a medical image receiving system 100e.

FIG. 8 is a transmission screen of a medical image.

FIG. 9 is a receiving screen of a medical image.

FIG. 10 is a transmission screen for transmitting a reading request.

FIG. 11 is a receiving screen for receiving a reading request.

FIG. 12 is a table illustrating patient ID conversion rules.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In contrast, a system for mutually exchanging medical image data between a plurality of medical institutions is required in one local area, an administrative boundary unit or a living area unit. Namely, the system is N:N data exchange.

However, for medical image data exchange between a plurality of medical institutions, a relay system is necessarily configured depending on the installation status of a medical image control system (Picture Archiving and Communication Systems (PACS)): a medical image management system or Hospital Information System (HIS): an electronic chart system of each medical institution. Thus, the system becomes complicated, causing an increase in improvement cost.

Hence, the present invention has been made in consideration of such unsolved problems in the conventional art. An object of the present invention is to provide a medical image exchange system and an image relay server, which allow a plurality of medical institutions to easily exchange medical image data between them without significantly changing the configurations of their respective image control systems.

### [First Aspect]

In order to achieve the above object, a medical image exchange system of a first aspect for connecting an image relay server to one or a plurality of first medical image transmission systems used in a medical institution, one or a plurality of second medical image transmission systems used in a medical institution, one or a plurality of first medical image receiving systems used in a medical institution, one or a plurality of second medical image receiving systems used in a medical institution, and one or a plurality of third medical image receiving systems used in a medical institution, in a communicatable manner, and exchanging medical image data between a plurality of medical institutions, wherein

the first medical image transmission system includes:
an in-hospital terminal;
a relay server;
a medical image display terminal; and
an in-hospital information system,

the in-hospital information system includes:
a transmission destination input device configured to input a transmission destination of medical image data held by the medical image display terminal in response to a request from the in-hospital terminal;
a medical image data selection device configured to select any of the medical image data held by the medical image display terminal in response to a request from the in-hospital terminal;
an image relay form generation device configured to generate an image relay form including relay information on the transmission destination input by the transmission destination input device, and image identification information for identifying the medical image data selected by the medical image data selection device; and
a first image relay form transmission device configured to transmit the image relay form generated by the image relay form generation device to the relay server,

the relay server includes:
a first image relay form receiving device configured to receive an image relay form; and
a second image relay form transmission device configured to transmit an image relay form received by the first receiving form receiving device to the relay server,

the image relay server includes:
a second image relay form receiving device configured to receive the image relay form; and
a first acquisition request transmission device configured to transmit a request to acquire the medical image data to the relay server based on the image relay form received by the second image relay form receiving device,

the relay server further includes:
a medical image data acquisition device configured to acquire the medical image data from the medical image display terminal in response to the acquisition request; and
a first medical image data transmission device configured to transmit to the image relay server the medical image data acquired by the medical image data acquisition device,

the image relay server further includes:
a medical image database;
a medical image data receiving device configured to receive the medical image data; and
a medical image data storing device configured to store the medical image data received by the medical image data receiving device in the medical image database,

the second medical image transmission system includes:
an in-hospital terminal;
a relay server; and
a medical image display terminal,

the image relay server further includes:
a transmission purpose input device in the first medical image transmission system,
the medical image data selection device,
the same device as the image relay form generation device, and
a second acquisition request transmission device configured to transmit a request to acquire the medical image data to the relay server on based on image relay form generated by the image relay form generation device;

the relay server includes:
the medical image data acquisition device in the first medical image transmission system, and
the same device as the first medical image data transmission device;

the first medical image receiving system includes:
an in-hospital terminal;
a relay server;
a medical image display terminal; and
an in-hospital information system,

the image relay server further includes:
a second medical image data transmission device configured to transmit the medical image data to the relay server based on an image relay form received by the second image relay form receiving device or generated by the image relay form generation device,

the relay server includes:
the medical image database in the image relay server;
a medical image data receiving device; and
the same device as the medical image data storing device configured to store the medical image data,

the image relay server thither includes third image relay form transmission device configured to transmit the image form to the relay server based on the image relay form received by the second image relay form receiving device or generated by the image relay form generation device,

the relay server further includes a third image relay form receiving device configured to receive the image relay form,

the in-hospital information system includes:
an image relay form acquisition device configured to acquire the image relay form from the relay server in response to a request from the in-hospital terminal; and
a first capture request transmission device configured to transmit a request to capture the medical image data to the relay server based on the image relay form acquired by the image relay form acquisition device in response to a request from the in-hospital terminal, and

the relay server thither includes a third medical image data transmission device configured to transmit the medical image data in the medical image database to the medical image display terminal in response to the capture request,

the second medical image receiving system includes:
an in-hospital terminal;
a relay server; and
a medical image display terminal,

the relay server includes:
the medical image database in the image relay server;
the medical image data receiving device; and
the same device as the medical image data storing device and the third medical image data transmission device in the first medical image receiving system,

the image relay server further includes second capture request transmission device for transmitting a request to capture the medical image data to the relay server based on the image relay form received by the second image relay form receiving device or generated by the image relay form generation device in response to a request from the in-hospital terminal,

the third medical image receiving system includes an in-hospital terminal,

the image relay server further includes a fourth medical image data transmission device configured to transmit the medical image data in the medical image database to the in-hospital terminal based on the image relay form received by the second image relay form receiving device or generated by the image relay form generation device in response to a request from the in-hospital terminal.

With such a configuration, the following operation can be obtained.

### [Transmission by First Medical Image Transmission System]

If the first medical image transmission system is connected in a communicatable manner, transmission is performed by the first medical image transmission system as follows:

The transmission destination input device inputs a transmission destination of medical image data into the in-hospital information system in response to a request from the in-hospital terminal. The medical image data selection device selects any of medical image data in response to a request from the in-hospital terminal. The image relay form generation device generates an image relay form including relay information of the input transmission destination and image identification information of the selected medical image data. The first image relay form transmission device transmits the generated image relay form to the relay server.

In the relay server, when the first image relay form receiving device receives the image relay form, the second image relay form transmission device transmits the received image relay form to the image relay server.

In the image relay server, when the second image relay form receiving device receives the image relay form, the first acquisition request transmission device transmits a request to acquire the medical image data to the relay server based on the received image relay form.

In the relay server, the medical image data acquisition device acquires the medical image data from the medical image display terminal in response to the acquisition request. Furthermore, the first medical image data transmission device transmits the acquired medical image data to the image relay server.

In the image relay server, when the medical image data receiving device receives the medical image data, the medical image data storing device records the received medical image data, in the medical image database.

### [Transmission by Second Medical Image Transmission System]

If the second medical image transmission system is connected in a communicatable manner, transmission is performed by the second medical image transmission system as follows:

The transmission destination input device inputs a transmission destination of medical image data into the image relay server in response to a request from the in-hospital terminal. The medical image data selection device selects any of medical image data in response to a request from the in-hospital terminal. The image relay form generation device generates an image relay form including relay information of the input transmission destination and image identification information of the selected medical image data. The second acquisition request transmission device transmits a request to acquire the medical image data to the relay server based on the generated image relay form.

In the relay server, the medical image data acquisition device acquires the medical image data from the medical image display terminal in response to the acquisition request. The first medical image data transmission device transmits the acquired medical image data to the image relay server.

In the image relay server, when the medical image data receiving device receives the medical image data, the medical image data storing device records the received medical image data in the medical image database.

### [Reception by First Medical Image Receiving System]

If the first medical image receiving system is connected in a communicatable manner, reception is performed by the first medical image receiving system as follows:

In the image relay server, the second medical image data transmission device transmits the medical image data recorded in the medical image database to the image relay server based on the received and generated image relay form.

In the relay server, when the medical image data receiving device receives the medical image data, the medical image data storing device records the received medical image data in the medical image database.

Moreover, in the image relay server, the third image relay form transmission device transmits the image relay form to the relay server based on the received/generated image relay form.

In the relay server, the third image relay form receiving device receives the image relay form. In the in-hospital information system, the image relay form acquisition device acquires the image relay form from the relay server in response to a request from the in-hospital terminal. The first capture request transmission device transmits a request to capture the medical image data to the relay server based on the acquired image relay form in response to a request from the in-hospital terminal.

In the relay server, the third medical image data transmission device transmits the medical image data recorded in the medical image database to the medical image display terminal in response to the capture request.

When receiving the medical image data, the medical image display terminal can display a medical image based on the received medical image data.

### [Reception by Second Medical Image Receiving System]

If the second medical image receiving system is connected in a communicatable manner, reception is performed by the second medical image receiving system as follows:

In the image relay server, the second medical image data transmission device transmits the medical image data recorded in the medical image database to the relay server based on the received/generated image relay form.

In the relay server, when the medical image data receiving device receives the medical image data, the medical image data storing device records the received medical image data in the medical image database.

Moreover, in the image relay server, the second capture request transmission device transmits a request to capture the medical image data to the relay server based on the received/generated image relay form in response to a request from the in-hospital terminal.

In the relay server, the third medical image data transmission device transmits the medical image data recorded in the medical image database to the medical image display terminal in response to the capture request.

When receiving the medical image data, the medical image display terminal can display a medical image based on the received medical image data.

### [Reception by Third Medical Image Receiving System]

If the third medical image receiving system is connected in a communicatable manner, reception is performed by the third medical image receiving system as follows:

In the image relay server, the fourth medical image data transmission device transmits the medical image data recorded in the medical image database to the in-hospital terminal based on the received/generated image relay form in response to a request from the in-hospital terminal.

When receiving the medical image data, the in-hospital terminal can display a medical image based on the received medical image data.

### [Second Aspect]

Furthermore, the medical image exchange system of the second aspect, in the medical image exchange system of the first aspect,

the medical image display terminal in the first medical image transmission system includes medical image data including the patient identification information unique to the medical institution using the first medical image transmission system,

the relay server in the first medical image transmission system further includes:
a first patient identification information database configured to associate the common patient identification information that is independent of a medical institution and the patient identification information unique to a medical institution using the first medical image transmission system, and stores them on a patient-by-patient basis, and
a first patient identification information conversion device configured to convert the unique patient identification information included in medical image data acquired by the medical image data acquisition device based on the first patient identification information database to the common patient identification information,

the relay server in the first medical image receiving system includes further includes a second patient identification information database configured to associate the common patient identification information and the patient identification information unique to a medical institution using the first medical image receiving system, and stores them on a patient-by-patient basis,

the second patient identification information conversion device configured to convert the common patient identification information included in medical image data received by the medical image data receiving device based on the second patient identification information database to the unique patient identification information.

With such a configuration, the following operation can be obtained.

### [Transmission by First Medical Image Transmission System]

If the first medical image transmission system is connected in a communicatable manner, transmission is performed by the first medical image transmission system as follows:

In the relay server, when the medical image data acquisition device acquires medical image data, the first patient identification information conversion device converts, to the common patient identification information, the unique patient identification information included in the acquired medical image data based on the first patient identification information database. The first medical image data transmission device transmits the converted medical image data to the image relay server.

### [Reception by First Medical Image Receiving System]

If the first medical image receiving system is connected in a communicatable manner, reception is performed by the first medical image receiving system as follows:

In the relay server, when the medical image data receiving device receives medical image data, the second patient identification information conversion device converts, to the unique patient identification information, the common patient identification information included in the received medical image data based on the second patient identification information database. The medical image data storing device records the converted medical image data in the medical image database.

### [Third Aspect]

On the other hand, in order to achieve the above object, an image relay server of a third aspect is the image relay server in the medical image exchange system of any of the first and second aspects.

With such a configuration, an equivalent operation to that of the medical image exchange system of any of the first and second aspects can be obtained.

As described above, according to the medical image exchange system of the first aspect, what has to be done is mainly simple installation of the relay server in a medical institution. Moreover, the flow of the medical image data is controlled based on the image relay form. Hence, medical image data can be relatively easily exchanged between a plurality of medical institutions compared with before without significantly changing the configurations of their respective image control systems.

Furthermore, according to the medical image exchange system of the second aspect, it becomes possible to deal with medical image data with unique patient identification information that can be easily used by each medical institution. Hence, it is possible to reduce the possibility where a medical error such as a medical image data mix-up occurs.

On the other hand, according to the image relay server of the third aspect, an equivalent effect to the medical image exchange system of any of the first and second aspects can be obtained.

Hereinafter, an embodiment of the present invention will be described. Firstly described is a configuration of a medical image exchange system according to the embodiment.

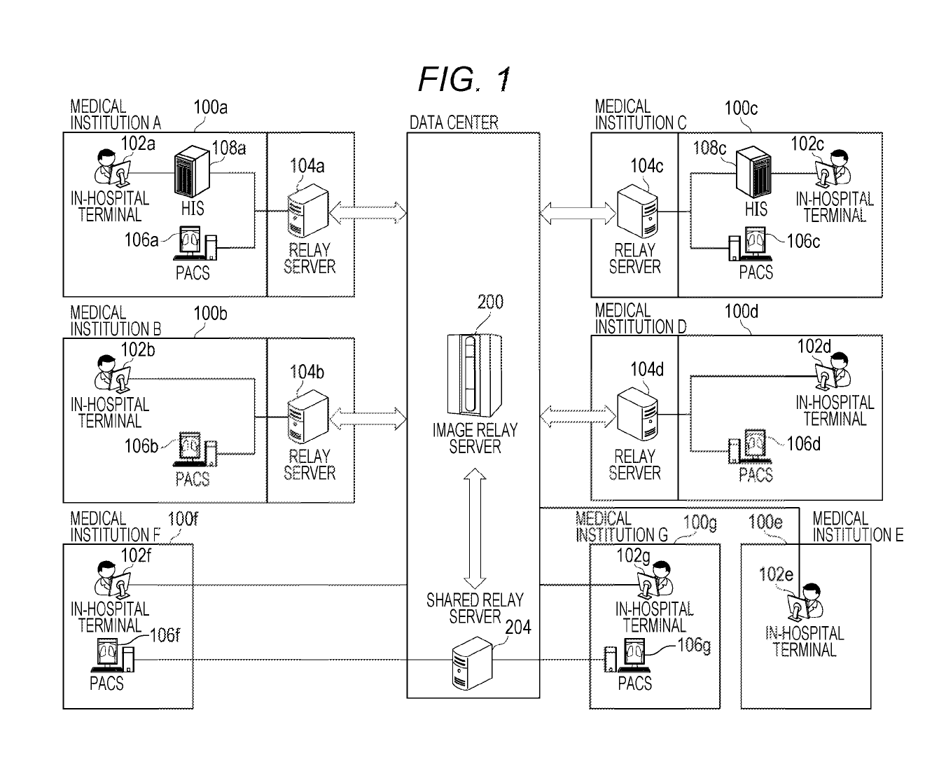

FIG. 1 is a diagram illustrating an outline of an entire configuration of the medical image exchange system according to the embodiment. By way of example, FIG. 1 illustrates seven medical institutions A to G existing in one area corresponding to an administrative boundary unit or a living area unit. An object of the medical image exchange system is to mutually exchange medical image data between the medical institutions A to G.

A medical image transmission system 100a is installed in the medical institution A, a medical image transmission system 100b in the medical institution B, a medical image receiving system 100c in the medical institution C, a medical image receiving system 100d in the medical institution D, a medical image receiving system 100e in the medical institution E, a medical image transmission system 100f in the medical institution F, and a medical image receiving system 100g in the medical institution G.

An image relay server 200 and a shared relay server 204 are installed in a data center. The shared relay server 204 is connected to the image relay server 200 via a network such as a LAN.

The medical image transmission system 100a includes an in-hospital terminal 102a, a relay server 104a, a PACS 106a, and an HIS 108a. The in-hospital terminal 102a is respectively connected to the HIS 108a, and the PACS 106a and the HIS 108a to the relay server 104a via a network such as a LAN.

The medical image transmission system 100b includes an in-hospital terminal 102b, a relay server 104b, and a PACS 106b. The in-hospital terminal 102b and the PACS 106b are connected to the relay server 104b via a network such as a LAN.

The medical image receiving system 100c includes an in-hospital terminal 102c, a relay server 104c, a PACS 106c, and an HIS 108c. The in-hospital terminal 102c is connected to the HIS 108c, and the PACS 106c and the HIS 108c to the relay server 104c, respectively via a network such as a LAN.

The medical image receiving system 100d includes an in-hospital terminal 102d, a relay server 104d, and a PACS 106d. The in-hospital terminal 102d and the PACS 106d are connected to the relay server 104d via a network such as a LAN.

The medical image receiving system 100e includes an in-hospital terminal 102e. The medical image transmission system 100f includes an in-hospital terminal 102f and a PACS 106f. Furthermore, the medical image receiving system 100g includes an in-hospital terminal 102g and a PACS 106g.

The relay servers 104a, 104b, 104c, and 104d, and the in-hospital terminals 102e, 102f, and 102g are connected to the image relay server 200 via a network such as a VPN. The PACSs 106f and 106g are connected to the shared relay server 204 via a network such as a VPN.

The shared relay server 204 is a relay server shared between the medical image transmission system 100f and the medical image receiving system 100g, and has functions equivalent to those of the relay servers 104b and 104d. In other words, the medical image transmission system 100f attains functions equivalent to those of the medical image transmission system 100b by using the shared relay sever 204. Similarly, the medical image receiving system 100g also attain functions equivalent to those of the medical image receiving system 100d by using the shared relay server 204. Therefore, costs for system installation and operation can be reduced. The medical image transmission system 100b and the medical image receiving system 100d will be described while omitting the detailed description of the medical image transmission system 100f, the medical image receiving system 100g, and the shared relay server 204.

The in-hospital terminal 102a is configured to have the same function as a general computer in which, for example, a central processing unit (CPU), a read only memory (ROM), a random access memory (RAM), and an I/F are connected to one another via a bus. The I/F is connected to a storage device such as an HDD, a display device such as a display, or a network cable. The in-hospital terminals 102b to 102g have the same hardware configuration as the in-hospital terminal 102a.

The relay server 104a is configured to have the same functions as a general computer in which, for example, a CPU, a ROM, a RAM, and an I/F are connected to one another via a bus. The I/F is connected to a storage device such as an HDD, a display device such as a display, and a network cable. The relay servers 104b to 104d have the same hardware configuration as the relay server 104a.

The PACS 106a is configured to have the same function as a general computer in which, for example, a CPU, a ROM, a RAM, and an I/F are connected to one another via a bus. The I/F is connected to a storage device such as an HDD, a display device such as a display, and a network cable. The PACSs 106b to 106d, 106f and 106g have the same hardware configuration as the PACS 106a.

The HIS 108a is configured to have the same functions as a general computer in which, for example, a CPU, a ROM, a RAM, and an I/F are connected to one another via a bus. The I/F is connected to a storage device such as an HDD, a display device such as a display, and a network cable. The HIS 108c has the same hardware configuration as the HIS 108a.

The image relay server 200 is configured to have the same function as a general computer in which, for example, a CPU, a RUM, a RAM, and an I/F are connected to one another via a bus. The I/F is connected to a storage device such as an HDD, a display device such as a display, and a network cable.

The present embodiment employs a two-step transfer method. Here, the method enables the transfer of medical image data between a transmitting side medical institution and a receiving side medical institution via a data center provided therebetween. The transmitting side medical institution transmits medical image data to the data center. The receiving side medical institution receives the medical image data from the data center. Data is transferred by the “relay server” disposed between the transmitting side medical institution and the data center in the first step and by the “relay server” disposed between the data center and the receiving side medical institution in the second step. The medical image data is transferred in two steps to complete the transfer. In the first step, the relay server of the transmitting side medical institution acquires medical image data from the PACS and transmits the medical image data to the image relay server 200. The image relay server 200 records the medical image data in its own storage device. In the second step, the relay server of the receiving side medical institution receives the medical image data from the image relay server 200. The relay server of the receiving side medical institution records the medical image data in its own storage device. The in-hospital terminal of the receiving side medical institution issues a capture order to the PACS. As a consequence, the medical image data is made possible to be referenced. Hence, the medical image data can be transferred from the transmitting side medical institution to the receiving side medical institution.

Next, a description will be given of a data structure of an image relay form for controlling the flow of medical image data. The image relay form is information used by the image relay server 200 and the like to control the flow of medical image data. The image relay form acts as a guide for delivering medical image data from the transmitting side medical institution to the receiving side medical institution.

The transmitting side medical institution generates an image relay form and transmits the image relay form to the image relay server 200. The image relay server 200 requests the relay server of the transmitting side medical institution to transmit medical image data based on the image relay form. When the medical image data is delivered to the image relay server, then a request to receive the medical image data is made to the relay server of the receiving side medical institution. The in-hospital terminal of the receiving side medical institution issues a capture order to the PACS. As a consequence, it becomes possible to reference the medical image data. Hence, the medical image data can be transferred from the transmitting side medical institution to the receiving side medical institution. Once the medical image data has been delivered to the receiving side medical institution, it leads to a state where the image relay form has been delivered from the receiving side medical institution, and it is made possible to reference the medical image data.

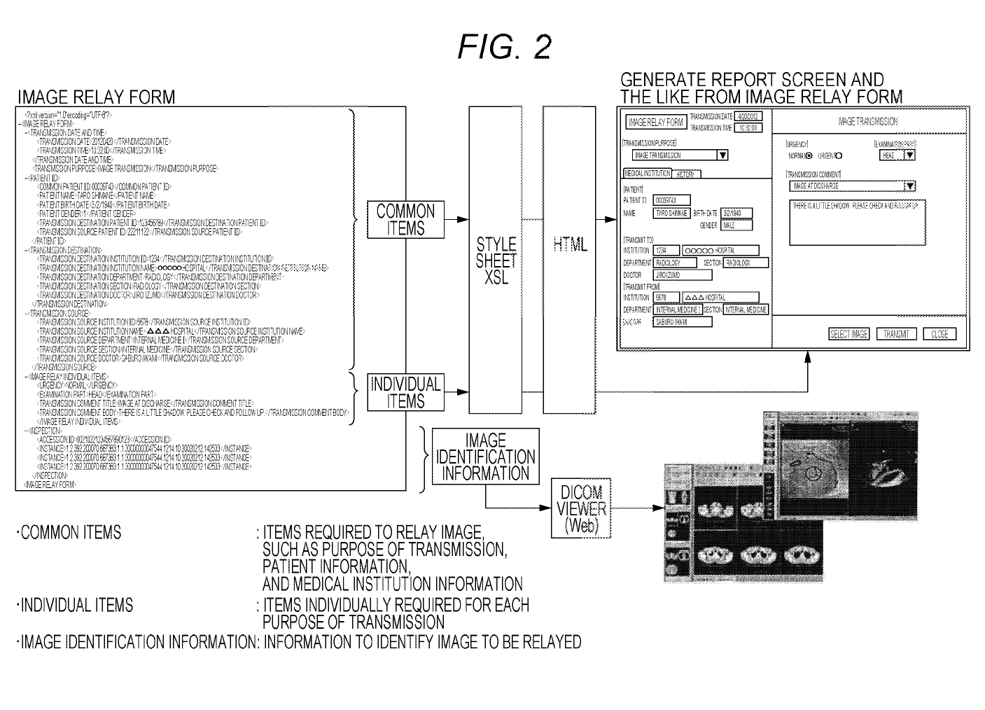

FIG. 2 is a diagram illustrating a data structure of the image relay form. As illustrated in FIG. 2, the image relay form includes information on common items, information on individual items, and image identification information for identifying medical image data. The image relay form can be described in, for example, XML (eXtensible Markup Language).

The information on the common items includes the date and time of transmission, the purpose of transmission, patient information on a patient, medical institution information on a medical institution of a transmission destination of medical image data, and medical institution information on a medical institution of a transmission source of the medical image data. The patient information includes a patient ID for identifying a patient. For example, a referral of a patient to another medical institution, transmission of a medical image to another medical institution, and a reading request to another medical institution can be set as the purpose of transmission.

The information on the individual items includes, for example, the level of urgency, an examination portion, a heading of a transmission comment, and a body of the transmission comment.

The image relay form can be converted by XSL (eXtensible Stylesheet Language) to HTML (Hyper Text Markup Language) data in an arbitrary format. The in-hospital terminal and the like can display a report screen and the like based on the converted HTML data. Moreover, the in-hospital terminal and the like can display a medical image by a DICOM (Digital Imaging and COmmunication in Medicine) viewer and the like based on medical image data associated with the image relay form.

Next, the operation of the embodiment will be described.

### [Transmission by Medical Image Transmission System 100a]

Firstly, the operation of transmission by the medical image transmission system 100a will be described.

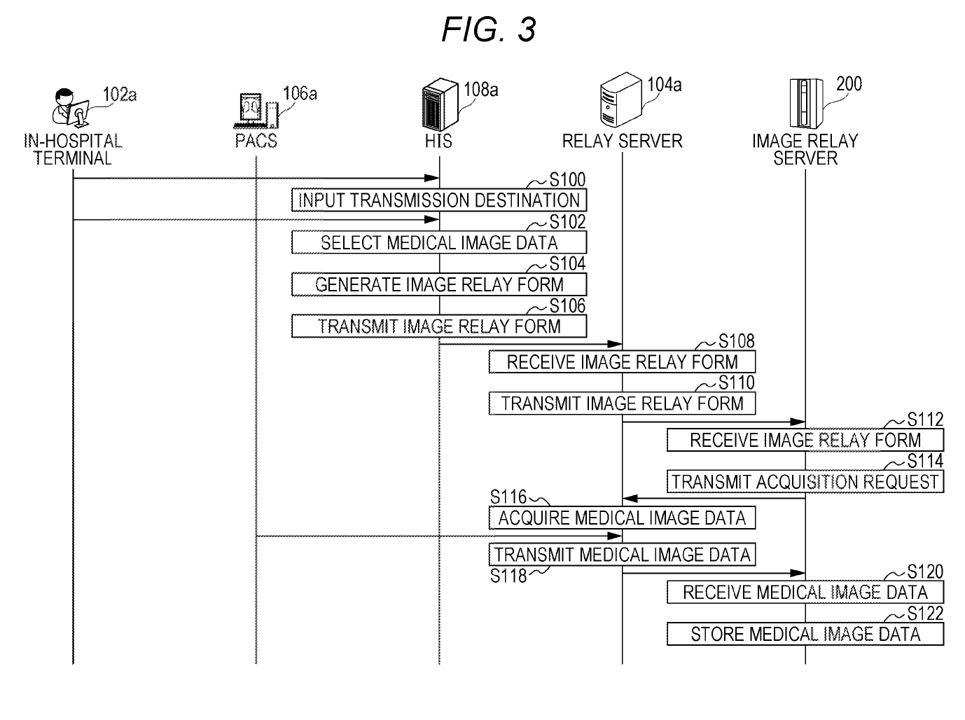

FIG. 3 is a sequence illustrating a medical image data transmission process to be executed between the medical image transmission system 100a and the image relay server 200.

As illustrated in FIG. 3, a transmission destination of medical image data is input into the HIS 108a in response to a request from the in-hospital terminal 102a through Step S100. In the HIS 108a, any of medical image data is selected in response to a request from the in-hospital terminal 102a through Step S102. The input of the transmission destination and the selection of the medical image are performed by a doctor and the like who belong to the medical institution A using a display screen of the in-hospital terminal 102a. An image relay form including medical institution information of the input transmission destination and image identification information of the selected medical image data is generated through Step S104. The generated image relay form is transmitted to the relay server 104a through Step S106.

When receiving the image relay form through Step S108, the relay server 104a transmits the received image relay form to the image relay server 200 through Step S110.

When receiving the image relay form through Step S112, the image relay server 200 transmits a request to acquire the medical image data to the relay server 104a based on received the image relay form through Step S114.

The relay server 104a acquires the medical image data from the PACS 106a in response to the acquisition request through Step S116. Furthermore, the acquired medical image data is transmitted to the image relay server 200 through Step S118.

When receiving the medical image data through Step S120, the image relay server 200 records the received medical image data in a storage device through Step S122.

### [Transmission by Medical Image Transmission System 100b]

Next, the operation of transmission by the medical image transmission system 100b will be described.

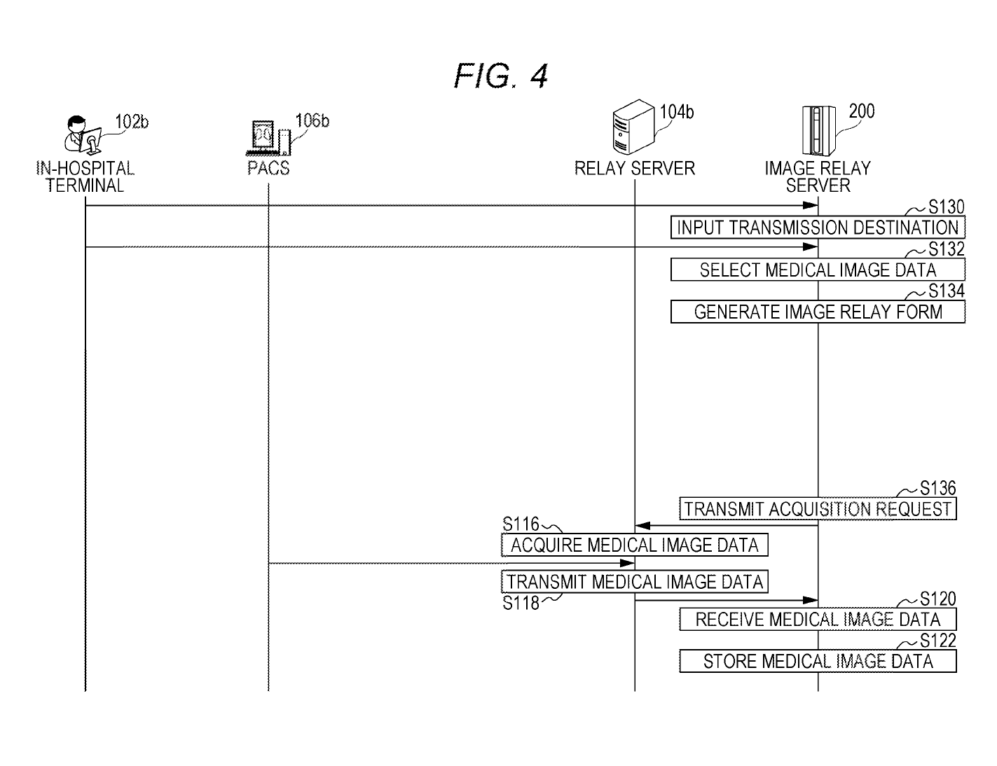

FIG. 4 is a sequence illustrating a medical image data transmission process to be executed between the medical image transmission system 100b and the image relay server 200.

As illustrated in FIG. 4, a transmission destination of medical image data is input into the image relay server 200 in response to a request from the in-hospital terminal 102b through Step S130. In the image relay server 200, any of medical image data is selected in response to a request from the in-hospital terminal 102b through Step S132. The input of the transmission destination and the selection of the medical image are performed by a doctor and the like who belong to the medical institution B using a display screen of the in-hospital terminal 102b. An image relay form including medical institution information of the input transmission destination and image identification information of the selected medical image data is generated through Step S134. A request to acquire the medical image data is transmitted to the relay server 104b based on the generated image relay form through Step S136.

The relay server 104b acquires the medical image data from the PACS 106b in response to the acquisition request through Step S116. Furthermore, the acquired medical image data is transmitted to the image relay server 200 through Step S118.

When receiving the medical image data through Step S120, the image relay server 200 records the received medical image data in the storage device through Step S122.

### [Reception by Medical Image Receiving System 100c]

Next, the operation of reception by the medical image receiving system 100c will be described.

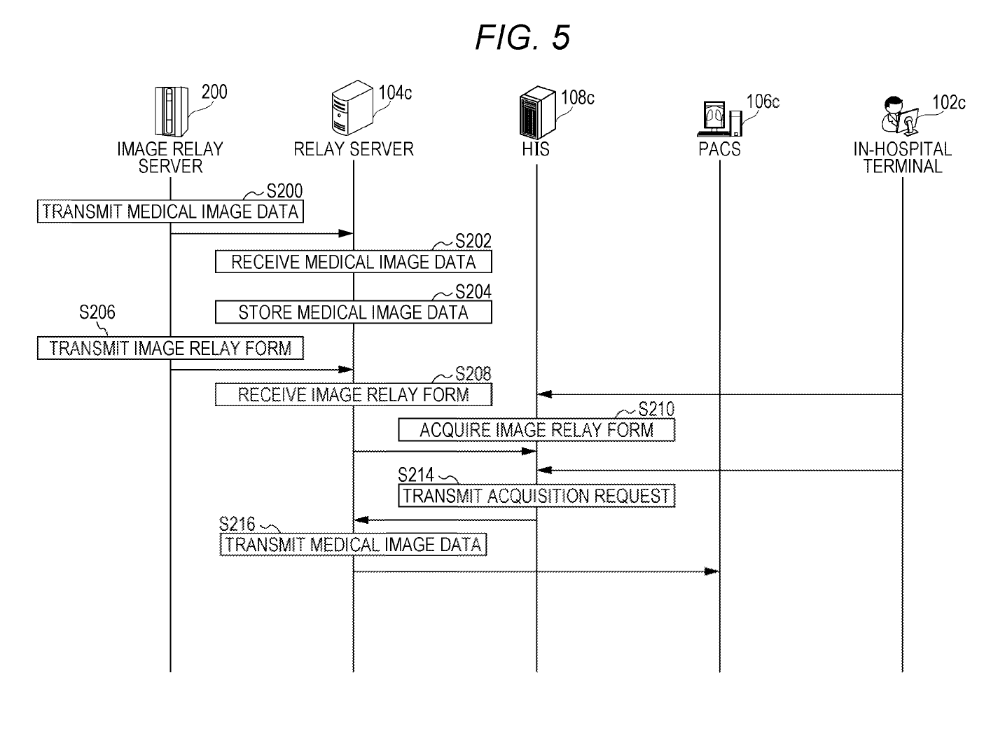

FIG. 5 is a sequence illustrating a medical image data receiving process to be executed between the image relay server 200 and the medical image receiving system 100c.

As illustrated in FIG. 5, the image relay server 200 transmits medical image data to the relay server 104c based on the received/generated image relay form through Step S200.

When receiving the medical image data through Step S202, the relay server 104c records the received medical image data in a storage device through Step S204.

Moreover, the image relay server 200 transmits the received/generated image relay form to the relay server 104c based on the image relay form through Step S206.

The relay server 104c receives the image relay form through Step S208. The HIS 108c acquires the image relay form from the relay server 104c in response to a request from the in-hospital terminal 102c through Step S210. Furthermore, a request to capture the medical image data is transmitted to the relay server 104c based on the acquired image relay form in response to a capture order from the in-hospital terminal 102c through Step S214. The medical image capture order is given by a doctor and the like who belong to the medical institution C on a display screen of the in-hospital terminal 102c.

The relay server 104c transmits the medical image data to the PACS 106c in response to the capture request through Step S216.

When receiving the medical image data, the PACS 106c displays a medical image based on the received medical image data.

### [Reception by Medical Image Receiving System 100d]

Next, the operation of reception by the medical image receiving system 100d will be described.

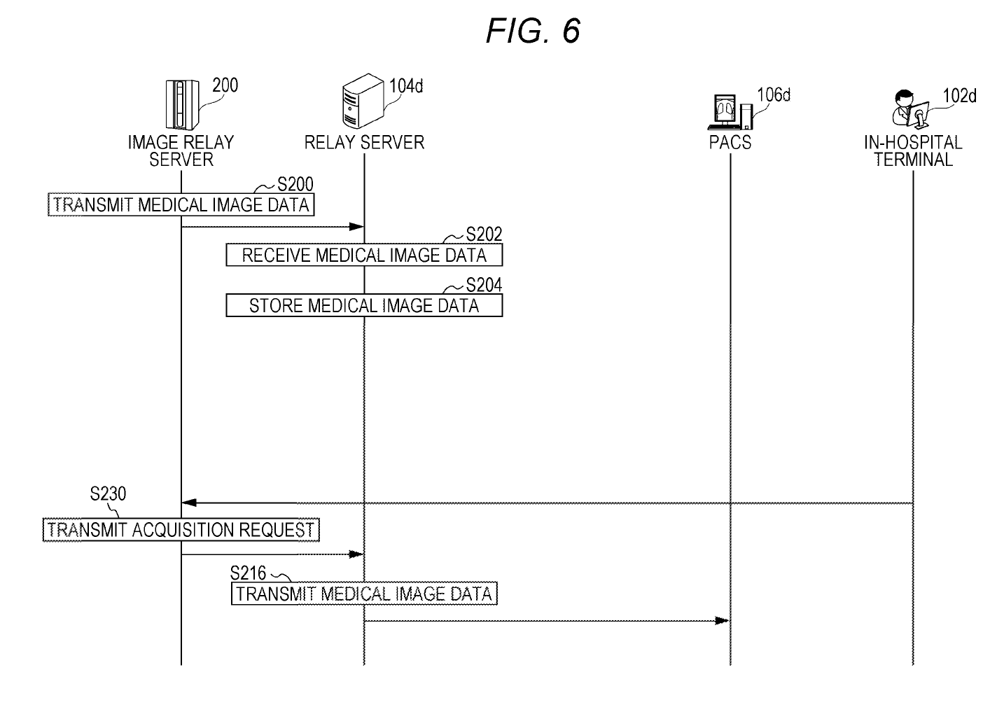

FIG. 6 is a sequence illustrating a medical image data, receiving process to be executed between the image relay server 200 and the medical image receiving system 100d.

As illustrated in FIG. 6, the image relay server 200 transmits medical image data to the relay server 104d based on the received/generated image relay form through Step S200.

When receiving the medical image data through Step S202, the relay server 104d records the received medical image data in a storage device through Step S204.

Moreover, the image relay server 200 transmits a request to capture the medical image data to the relay server 104d based on the received/generated image relay form in response to the capture order from the in-hospital terminal 102 through Step S230. The medical image capture order is given by a doctor and the like who belong to the medical institution D on a display screen of the in-hospital terminal 102d.

The relay server 104d transmits the medical image data to the PACS 106d in response to the capture request through Step S216.

When receiving the medical image data, the PACS 106d displays a medical image based on the received medical image data.

### [Reception by Medical Image Receiving System 100e]

Next, the operation of reception by the medical image receiving system 100e will be described.

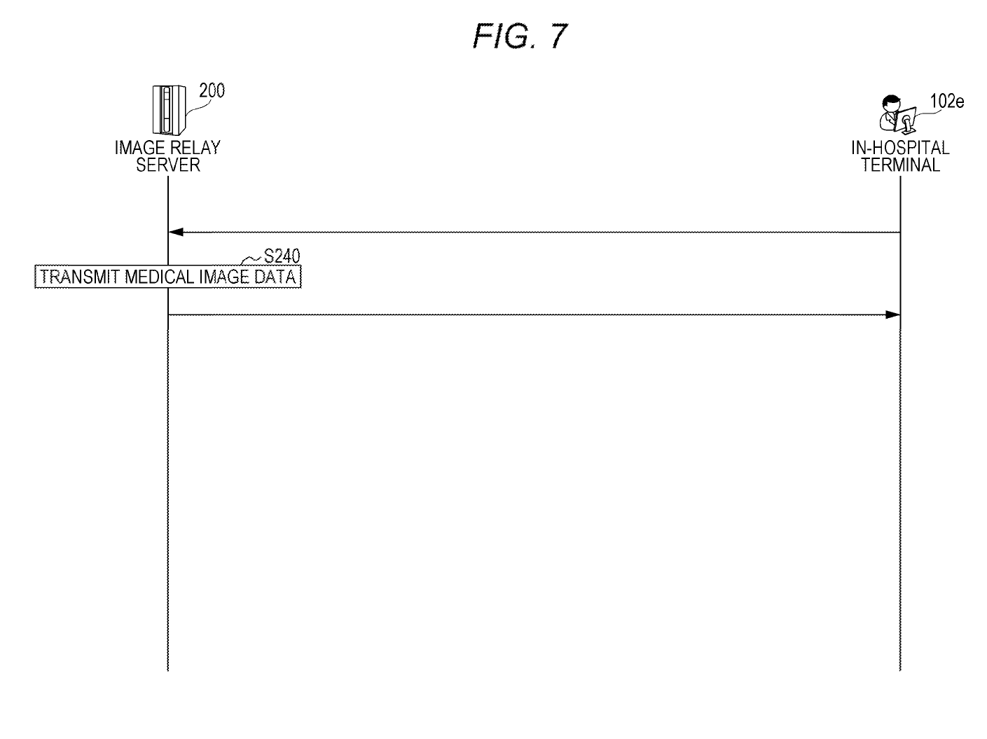

FIG. 7 is a sequence illustrating a medical image data receiving process to be executed between the image relay server 200 and the medical image receiving system 100e.

As illustrated in FIG. 7, the image relay server 200 transmits medical image data to the in-hospital terminal 102e based on the received/generated image relay form in response to a display order from the in-hospital terminal 102e through Step S240. The medical image display order is given by a doctor and the like who belong to the medical institution E on a display screen of the in-hospital terminal 102e.

When receiving the medical image data, the in-hospital terminal 102e displays a medical image based on the received medical image data.

Next, display screens based on the purposes of transmission will be described. Firstly, a description will be given of a case where the propose of transmission is “transmission of a medical image to another medical institution.”

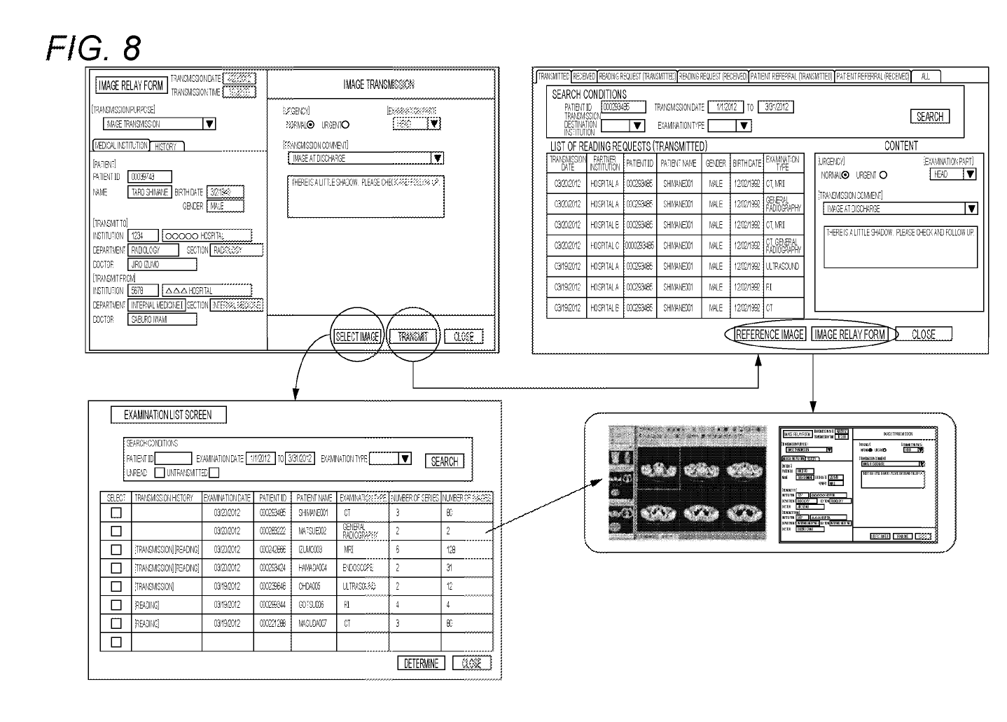

FIG. 8 is a transmission screen of a medical image. In the transmitting side medical institution, such a transmission screen as illustrated in FIG. 8 is displayed on the in-hospital terminal. The operation procedure includes (1) issuing an image relay form, (2) selecting “image transmission” as the purpose of transmission, (3) inputting pieces of information such as a patient ID, (4) associating a medical image, and (5) making a transmission request. Hence, the medical image and the image relay form can be referenced form from the transmission history.

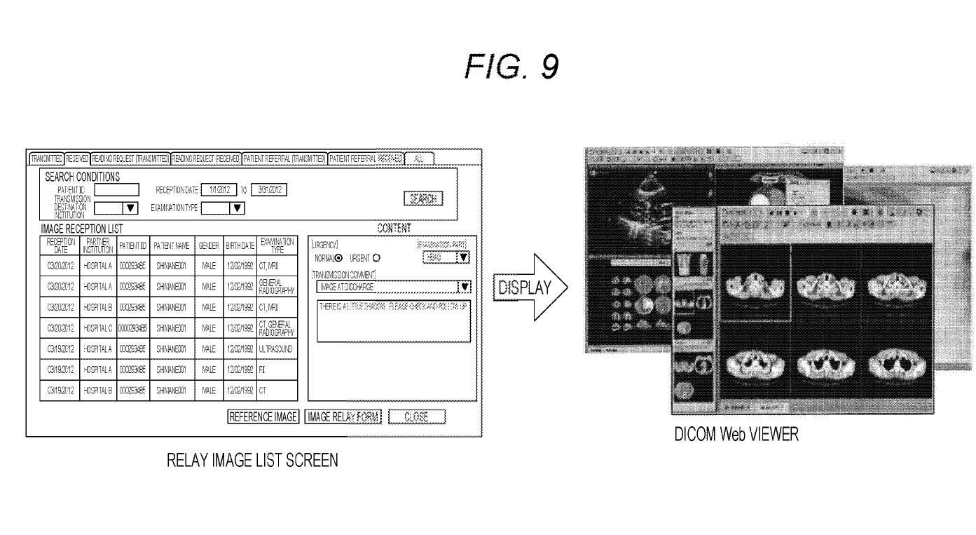

FIG. 9 is a receiving screen of a medical image. In the receiving side medical institution, such a receiving screen as illustrated in FIG. 9 is displayed on the in-hospital terminal. As the operation procedure, (1) the “received” tab is selected, and (2) a desired medical image is selected from the list. If the medical image is selected, the medical image is displayed by a DICOM viewer and the like.

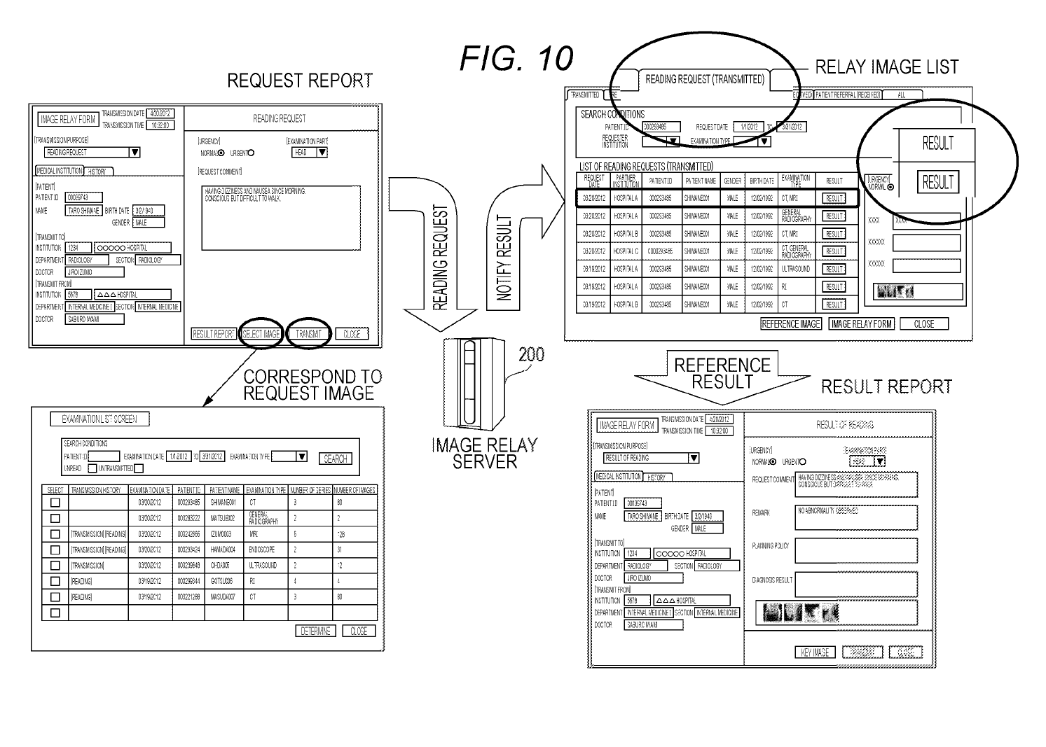

Next, a description will be given of a case where the purpose of transmission is a reading request to another medical institution. FIG. 10 is a transmission screen for transmitting a reading request.

In the transmitting side medical institution, such a transmission screen as illustrated in FIG. 10 is displayed on the in-hospital terminal. The operation procedure includes (1) issuing an image relay form, (2) selecting a “reading request” as the purpose of transmission, (3) inputting pieces of information such as a patient ID, (4) associating a medical image, and (5) making a transmission request. If the reading result is returned, the result report can be referenced from the transmission history.

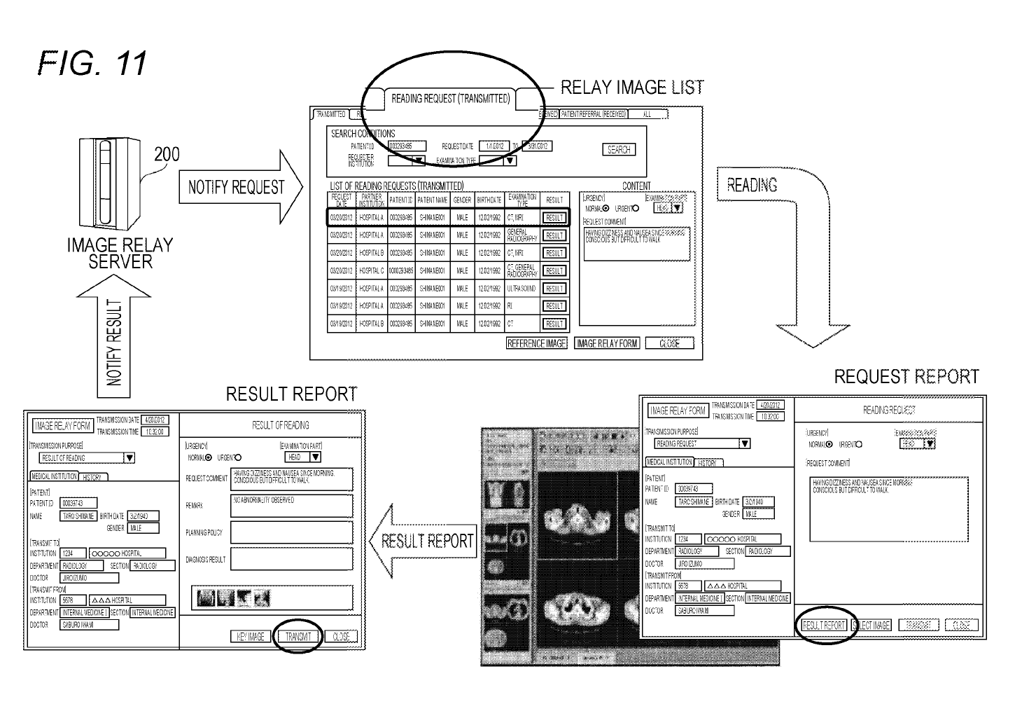

FIG. 11 is a receiving screen for receiving a reading request. In the receiving side medical institution, such a receiving screen as illustrated in FIG. 11 is displayed on the in-hospital terminal. As the operation procedure, (1) the “reading request (received)” tab is selected, and (2) a desired reading request is selected from the list. If the reading request is selected, a medical image is displayed by a DICOM viewer and the like. A doctor and the like read the medical image, and write the result in a result report.

In this manner, in the embodiment, what has to be done is mainly simple installation of the relay server in the medical institution. Moreover, the flow of medical image data is controlled based on an image relay form. Hence, medical image data can be relatively easily exchanged between a plurality of medical institutions compared with before without significantly changing the configurations of their respective medical image control systems.

In the embodiment, the PACS corresponds to the medical image display terminal of the first00 aspect. The HIS corresponds to the in-hospital information system of the first aspect. Steps S100 and S130 correspond to the transmission destination input device of the first aspect. Steps S102 and S132 correspond to the medical image data selection device of the first aspect. Moreover, Steps S104 and S134 correspond to the image relay form generation device of the first aspect. Step S106 corresponds to the first image relay form transmission device of the first aspect. Step S108 corresponds to the first image relay form receiving device of the first aspect. Step S110 corresponds to the second image relay form transmission device of the first aspect.

Moreover, in the embodiment. Step S112 corresponds to the second image relay form receiving device of the first aspect. Step S114 corresponds to the first acquisition request transmission device of the first aspect. Step S116 corresponds to the medical image data acquisition device of the first aspect. Step S118 corresponds to the first medical image data transmission device of the first aspect. Moreover, Steps S120 and S202 correspond to the medical image data receiving device of the first aspect. Steps S122 and S204 correspond to the medical image data storing device of the first aspect. Step S136 corresponds to the second acquisition request transmission device of the first aspect. Step S200 corresponds to the second medical image data transmission device of the first aspect.

Moreover, in the embodiment, Step S206 corresponds to the third image relay form transmission device of the first aspect. Step S208 corresponds to the third image relay form receiving device of the first aspect. Step S210 corresponds to the image relay form acquisition device of the first aspect. Step S214 corresponds to the first capture request transmission device of the first aspect. Moreover, Step S216 corresponds to the third medical image data transmission device of the first aspect. Step S230 corresponds to the second capture request transmission device of the first aspect. Step S240 corresponds to the fourth medical image data transmission device of the first aspect. The medical institution information corresponds to the relay information of the first aspect.

In the embodiment, the conversion of a patient ID is not particularly described. The embodiment is not limited to this, but it is also possible to associate patient IDs to centrally manage medical image data of a plurality of medical institutions and maintain the convenience of the medical institutions. A transmission source patient ID unique to the transmitting side medical institution, a transmission destination patient ID unique to the receiving side medical institution, and a common patient ID that is independent of the medical institutions are associated and thus the medical institutions can access medical image data with their own unique patient IDs. As a method for realizing this, a process of converting patient information (a patient ID) of a DICOM interface, included in the medical image data, by the transmitting side relay server and the receiving side relay server is carried out. A transmission source patient ID is set at the transmitting side medical institution. A common patient ID is set from the transmitting side relay server through the image relay server 200 to the receiving side relay server. A transmission destination patient ID is set at the receiving side medical institution. Specifically, the transmitting side relay server includes a transmitting side patient ID database that associates the common patient ID and the transmission source patient ID on a patient-by-patient basis and stores them. The transmitting side relay server converts, to the common patient ID, the transmission source patient ID included in the medical image data acquired from the PACS based on the transmitting side patient ID database. The receiving side relay server includes a receiving side patient ID database that associates the common patient ID and the transmission destination patient ID on a patient-by-patient basis and stores them. The receiving side relay server converts, to the transmission destination patient ID, the common patient ID included in the medical image data received from the image relay server 200 based on the receiving side patient ID database.

Consequently, it becomes possible to deal with medical image data with a unique patient ID that can be easily used by each medical institution. Therefore, it is possible to reduce the possibility where a medical error such as a medical image data mix-up occurs.

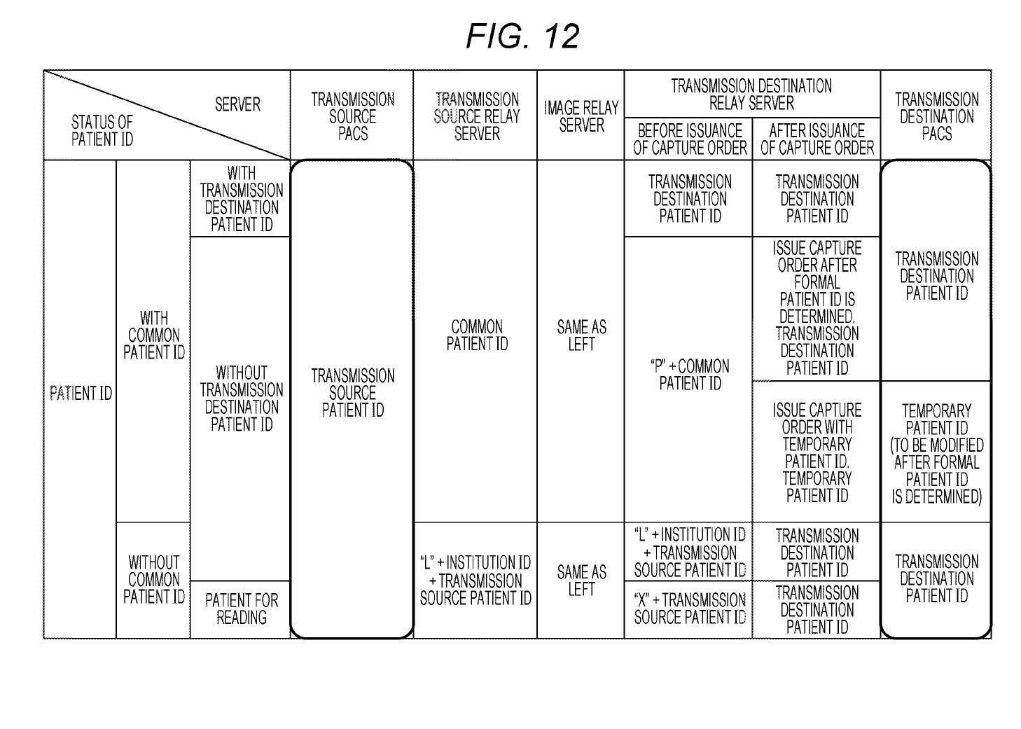

As illustrated in FIG. 12, the conversion process can be performed depending on the presence or absence of the common patient ID or transmission destination patient ID.

FIG. 12 is a table illustrating patient ID conversion rules. Moreover, in the embodiment, the PACSs 106a to 106d, 106f, and 106g are respectively installed in the medical institutions A to D, F, and G. The embodiment is not limited to this, but the installation of the PACS on the image relay server 200 of the data center enables a medical institution that has not installed the PACS to receive medical image data. In this case, the receiving side medical institution comes to use the PACS of the data center. Furthermore, medical image data through the data center is stored in the PACS of the data center and thus it becomes possible to store medical image data of a patient in an area and make effective use of the data in disaster situations.

In this case, an image view function can be further provided to make effective use of medical image data stored in the PACS of the data center. The image view function includes a function for a normal situation and a function for an emergency. The function for a normal situation gives a high priority to personal information protection. The medical institution can access only its own medical image data received or transmitted. A case related to a malfunction of the medical institution due to a disaster or to the life of a patient is assumed for the function for an emergency. All the medical image data stored in the PACS of the data center become accessible under permission of an operations manager. An access log is acquired in viewing medical image data at the time of an emergency. Therefore, a function to search for a patient name, the name of a medical institution, the name of a medical staff member, the date and time of use, and the like is provided in viewing medical image data at the time of an emergency to make the access traceable.

Moreover, in the embodiment, access restrictions to medical image data are not particularly described. The embodiment is not limited to this, but the following access restrictions can also be set.

(1) Medical institutions of a transmission source and a transmission destination of a relevant patient
(2) A doctor unit or medical institution unit to which the doctor belongs
(3) Medical image data transmitted to and received from a partner medical institution

Moreover, in the embodiment, the medical image transmission systems 100a, 100b, and 100f include the function to transmit medical image data, and the medical image receiving systems 100c to 100e, and 100g include the function to receive medical image data. The embodiment is not limited to this, but the medical image transmission systems 100a, 100b, and 100f may also include the function to receive medical image data. Furthermore, the medical image receiving systems 100c to 100e and 100g may also include the function to transmit medical image data.

In addition, the present disclosure can be also described as the following first to tenth medical image exchange systems, a first image relay server, a first medical image transmission system, a first medical image receiving system, a first relay server, and a first in-hospital information system.

A first medical image exchange system is a medical image exchange system for allowing a plurality of medical institutions to exchange medical image data between the medical institutions through an image relay server, the system being configured to communicatably connect the image relay server to one or a plurality of first medical image transmission systems used in each of the medical institutions, the first medical image transmission system including:
an in-hospital terminal;
a medical image display terminal;
a transmission destination input device configured to input a transmission destination of medical image data held by the medical image display terminal in response to a request from the in-hospital terminal;
a medical image data selection device configured to select any of the medical image data held by the medical image display terminal in response to a request from the in-hospital terminal;
an image relay form generation device configured to generate an image relay form including relay information on the transmission destination input by the transmission destination input device, and image identification information for identifying the medical image data selected by the medical image data selection device; and
an image relay form transmission device configured to transmit the image relay form generated by the image relay form generation device to the image relay server, wherein

the image relay server includes:
a second image relay form receiving device configured to receive the image relay form; and
a transmission device configured to transmit a request to acquire the medical image data to the first medical image transmission system based on the image relay form received by the second image relay form receiving device,

the first medical image transmission system further includes:
a medical image data acquisition device configured to acquire the medical image data, from the medical image display terminal in response to the acquisition request; and
a first medical image data transmission device configured to transmit to the image relay server the medical image data acquired by the medical image data acquisition device, and

the image relay server further includes:
a medical image database;
a medical image data receiving device configured to receive the medical image data; and
a medical image data storing device configured to store the medical image data received by the medical image data receiving device in the medical image database.

A second medical image exchange system is a medical image exchange system for allowing a plurality of medical institutions to exchange medical image data between the medical institutions through an image relay server, the system being configured to communicatably connect the image relay server to one or a plurality of second medical image transmission systems used in each of the medical institutions, the second medical image transmission system including:
an in-hospital terminal; and
a medical image display terminal, wherein

the image relay server includes:
a transmission destination input device configured to input a transmission destination of medical image data held by the medical image display terminal in response to a request from the in-hospital terminal;
a medical image data selection device configured to select any of the medical image data held by the medical image display terminal in response to a request from the in-hospital terminal;
an image relay form generation device configured to generate an image relay form including relay information on the transmission destination input by the transmission destination input device, and image identification information for identifying the medical image data selected by the medical image data selection device; and
a transmission device configured to transmit a request to acquire the medical image data to the second medical image transmission system based on the image relay form generated by the image relay form generation device,

the second medical image transmission system further includes:
a medical image data acquisition device configured to acquire the medical image data from the medical image display terminal in response to the acquisition request; and
a first medical image data transmission device configured to transmit to the image relay server the medical image data acquired by the medical image data acquisition device, and

the image relay server further includes:
a medical image database;
a medical image data receiving device configured to receive the medical image data; and
a medical image data storing device configured to store the medical image data received by the medical image data receiving device in the medical image database.

A third medical image exchange system is a medical image exchange system for allowing a plurality of medical institutions to exchange medical image data between the medical institutions through an image relay server, the system being configured to communicatably connect the image relay server to one or a plurality of first medical image transmission systems used in each of the medical institutions, the first medical image transmission system including:
an in-hospital terminal;
a relay server;
a medical image display terminal; and
an in-hospital information system, wherein

the in-hospital information system includes:
a transmission destination input device configured to input a transmission destination of medical image data held by the medical image display terminal in response to a request from the in-hospital terminal;
a medical image data selection device configured to select any of the medical image data held by the medical image display terminal in response to a request from the in-hospital terminal;
an image relay form generation device configured to generate an image relay form including relay information on the transmission destination input by the transmission destination input device, and image identification information for identifying the medical image data selected by the medical image data selection device; and
a first image relay form transmission device configured to transmit the image relay form generated by the image relay form generation device to the relay server,

the relay server includes:
a first image relay form receiving device configured to receive an image relay form; and
a second image relay form transmission device configured to transmit an image relay form received by the first image relay form receiving device to the relay server,

the image relay server includes:
a second image relay form receiving device configured to receive the image relay form; and
a first acquisition request transmission device configured to transmit a request to acquire the medical image data to the relay server based on the image relay form received by the second image relay form receiving device,

the relay server further includes:
a medical image data acquisition device configured to acquire the medical image data from the medical image display terminal in response to the acquisition request; and
a first medical image data transmission device configured to transmit to the image relay server the medical image data acquired by the medical image data acquisition device, and

the image relay server further includes:
a medical image database;
a medical image data receiving device configured to receive the medical image data; and
a medical image data storing device configured to store the medical image data received by the medical image data receiving device in the medical image database.

A fourth medical image exchange system is a medical image exchange system for allowing a plurality of medical institutions to exchange medical image data between the medical institutions through an image relay server, the system being configured to communicatably connect the image relay server to one or a plurality of second medical image transmission systems used in each of the medical institutions, the second medical image transmission system including:
an in-hospital terminal;
a relay server; and
a medical image display terminal, wherein

the image relay server includes:
a transmission destination input device configured to input a transmission destination of medical image data held by the medical image display terminal in response to a request from the in-hospital terminal;
a medical image data selection device configured to select any of the medical image data held by the medical image display terminal in response to a request from the in-hospital terminal;
an image relay form generation device configured to generate an image relay form including relay information on the transmission destination input by the transmission destination input device, and image identification information for identifying the medical image data selected by the medical image data selection device; and
a second acquisition request transmission device configured to transmit a request to acquire the medical image data to the relay server based on the image relay form generated by the image relay form generation device,

the relay server includes:
a medical image data acquisition device from the medical image display terminal in response to the acquisition request; and
a first medical image data transmission device configured to transmit to the image relay server the medical image data acquired by the medical image data acquisition device, and

the image relay server further includes:
a medical image database;
a medical image data receiving device configured to receive the medical image data; and
a medical image data storing device configured to store the medical image data received by the medical image data receiving device in the medical image database.

A fifth medical image exchange system is a medical image exchange system for allowing a plurality of medical institutions to exchange medical image data between the medical institutions through an image relay server, the system being configured to communicatably connect the image relay server to one or a plurality of first medical image receiving systems used in each of the medical institutions, the first medical image receiving system including:
an in-hospital terminal;
a relay server;
a medical image display terminal; and
an in-hospital information system, wherein

the image relay server includes second medical image data transmission device configured to transmit the medical image data to the relay server based on an image relay form including relay information on a transmission destination of the medical image data and image identification information for identifying the medical image data.

the relay server includes:
a medical image database;
a medical image data receiving device configured to receive the medical image data; and
a medical image data storing device configured to store the medical image data received by the medical image data receiving device in the medical image database,

the image relay server further includes third image relay form transmission device configured to transmit the image relay form to the relay server based on the image relay form,

the relay server further includes a third image relay form receiving device configured to receive the image relay form,

the in-hospital information system includes:
an image relay form acquisition device configured to acquire the image relay form from the relay server in response to a request from the in-hospital terminal; and
a first capture request transmission device configured to transmit a request to capture the medical image data to the relay server based on the image relay form acquired by the image relay form acquisition device in response to a request from the in-hospital terminal, and

the relay server further includes a third medical image data transmission device configured to transmit the medical image data in the medical image database to the medical image display terminal in response to the capture request.

A sixth medical image exchange system is a medical image exchange system for allowing a plurality of medical institutions to exchange medical image data between the medical institutions through an image relay server, the system being configured to communicatably connect the image relay server to one or a plurality of second medical image receiving systems used in each of the medical institutions, the second medical image receiving system including:
an in-hospital terminal;
a relay server; and
a medical image display terminal, wherein

the image relay server includes a second medical image data transmission device configured to transmit the medical image data to the relay server based on an image relay form including relay information on a transmission destination of the medical image data and image identification information for identifying the medical image data,

the relay server includes:
a medical image database;
a medical image data receiving device configured to receive the medical image data; and
a medical image data storing device configured to store the medical image data received by the medical image data receiving device in the medical image database,

the image relay server further includes a second capture request transmission device configured to transmit a request to capture the medical image data to the relay server based on the image relay form in response to a request from the in-hospital terminal, and

the relay server thither includes a third medical image data transmission device configured to transmit the medical image data in the medical image database to the medical image display terminal in response to the capture request.

A seventh medical image exchange system is a medical image exchange system for allowing a plurality of medical institutions to exchange medical image data between the medical institutions, the system being configured to communicatably connect one or a plurality of first medical image transmission systems used in a medical institution, an image relay server, and one or a plurality of the third medical image receiving systems used in a medical institution, wherein

the first medical image transmission system includes:
an in-hospital terminal;
a relay server;
a medical image display terminal; and
an in-hospital information system,

the in-hospital information system includes:
a transmission destination input device configured to input a transmission destination of medical image data held by the medical image display terminal in response to a request from the in-hospital terminal;
a medical image data selection device configured to select any of the medical image data held by the medical image display terminal in response to a request from the in-hospital terminal;
an image relay form generation device configured to generate an image relay form including relay information on the transmission destination input by the transmission destination input device, and image identification information for identifying the medical image data selected by the medical image data selection device; and
a first image relay form transmission device configured to transmit the image relay form generated by the image relay form generation device to the relay server,

the relay server includes:
a first image relay form receiving device configured to receive an image relay form; and
a second image relay form transmission device configured to transmit an image relay form received by the first a relay form receiving device to the image relay server,

the image relay server includes:
a second image relay form receiving device configured to receive the image relay form; and
a first acquisition request transmission device configured to transmit a request to acquire the medical image data to the relay server based on the image relay form received by the second image relay form receiving device,

the relay server further includes:
a medical image data acquisition device configured to acquire the medical image data from the medical image display terminal in response to the acquisition request; and
a first medical image data transmission device configured to transmit to the image relay server the medical image data acquired by the medical image data acquisition device,

the image relay server further includes:
a medical image database;
a medical image data receiving device configured to receive the medical image data; and
a medical image data storing device configured to store the medical image data received by the medical image data receiving device in the medical image database,

the third medical image receiving system includes an in-hospital terminal, and
the image relay server further includes a fourth medical image data transmission device configured to transmit the medical image data in the medical image database to the in-hospital terminal based on an image relay form received by the second image relay form transmission device in response to a request from the in-hospital terminal.

An eighth medical image exchange system is a medical image exchange system for allowing a plurality of medical institutions to exchange medical image data between the medical institutions, the system being configured to communicatably connect one or a plurality of second medical image transmission systems used in a medical institution, an image relay server, and one or a plurality of the third medical image receiving systems used in a medical institution, wherein

the second medical image transmission system includes:
an in-hospital terminal;
a relay server; and
a medical image display terminal,

the image relay server includes:
a transmission destination input device configured to input a transmission destination of medical image data held by the medical image display terminal in response to a request from the in-hospital terminal;
a medical image data selection device configured to select any of the medical image data held by the medical image display terminal in response to a request from the in-hospital terminal;
an image relay form generation device configured to generate an image relay form including relay information on the transmission destination input by the transmission destination input device, and image identification information for identifying the medical image data selected by the medical image data selection device; and
a second acquisition request transmission device configured to transmit a request to acquire the medical image data to the relay server based on the image relay form generated by the image relay form generation device,

the relay server further includes:
a medical image data acquisition device configured to acquire the medical image data from the medical image display terminal in response to the acquisition request; and
a first medical image data transmission device configured to transmit to the image relay server the medical image data acquired by the medical image data acquisition device,

the image relay server further includes:
a medical image database;
a medical image data receiving device configured to receive the medical image data; and
a storing device and a medical image data storing device configured to store the medical image data received by the medical image data receiving device and storing device in the medical image database,

the third medical image receiving system includes an in-hospital terminal, and

the image relay server further includes a fourth medical image data transmission device configured to transmit the medical image data in the medical image database to the in-hospital terminal based on an image relay form generated by the image relay form generation device in response to a request from the in-hospital terminal.

A ninth medical image exchange system is a medical image exchange system for allowing a plurality of medical institutions to exchange medical image data between the medical institutions, the system being configured to communicatably connect (A) a medical image transmission system to a medical image receiving system of any of (B-1) to (B-5) described below, where the medical image transmission system is the first medical image transmission system in the first, third and seventh medical image exchange systems or the second medical image transmission system in the second, fourth and eighth medical exchange systems, wherein

the medical image transmission system further includes a transmission destination input device configured to input the purpose of transmitting the medical image data,

the image relay form generation device generates an image relay form including the transmission purpose input by the transmission destination input device, and

the medical image receiving system further includes a medical image display device configured to display the medical image based on the transmission purpose included in the image relay form, wherein

(B-1) the medical image receiving system is a first medical image receiving system in a medical image exchange system configured to allow a plurality of medical institutions to exchange medical image data between the medical institutions through an image relay server, the system being configured to communicatably connect the image relay server to the one or a plurality of first medical image receiving systems used in each of the medical institutions, the medical image exchange system including the features that

the image relay server includes a transmission device configured to transmit the medical image data to the first medical image receiving system based on an image relay form having relay information on a transmission destination of the medical image data, and image identification information for identifying the medical image data,

the first medical image receiving system includes:
an in-hospital terminal;
a medical image display terminal;
a medical image database;
a medical image data receiving device configured to receive the medical image data; and
a medical image data storing device configured to store, in the medical image database, the medical image data received by the medical image data receiving device,

the image relay server further includes a transmission device configured to transmit the image relay form to the first medical image receiving system based on the image relay form, and

the first medical image receiving system further includes:
a third image relay form receiving device configured to receive the image relay form; and
a medical image data transmission device configured to transmit the medical image data in the medical image database to the medical image display terminal based on the image relay form received by the third image relay form receiving device in response to a request from the in-hospital terminal.

(B-2) the medical image receiving system is a first medical image receiving system in the fifth medical image exchange system,

(B-3) the medical image receiving system is a second medical image receiving system in a medical image exchange system configured to allow a plurality of medical institutions to exchange medical image data between the medical institutions through an image relay server, the system being configured to communicatably connect the image relay server to the one or a plurality of second medical image receiving systems used in each of the medical institutions, the medical image exchange system including the features that

the image relay server includes a transmission device configured to transmit the medical image data to the second medical image receiving system based on an image relay form having relay information on a transmission destination of the medical image data, and image identification information for identifying the medical image data,

the second medical image receiving system includes:
an in-hospital terminal;
a medical image display terminal;
a medical image database;
a medical image data receiving device configured to receive the medical image data; and
a medical image data storing device configured to store, in the medical image database, the medical image data received by the medical image data receiving device,

the image relay server further includes a transmission device configured to transmit a request to capture the medical image data to the second medical image receiving system based on the image relay form in response to a request from the in-hospital terminal, and

the second medical image receiving system further includes a third medical image data transmission device configured to transmit the medical image data in the medical image database to the medical image display terminal in response to the capture request,

(B-4) the medical image receiving system is a second medical image receiving system in the sixth medical image exchange system, and

(B-5) the medical image receiving system is a third medical image receiving system in a medical image exchange system configured to allow a plurality of medical institutions to exchange medical image data between the medical institutions through an image relay server, the system being configured to communicatably connect the image relay server to the one or a plurality of third medical image receiving systems used in each of the medical institutions, the medical image exchange system including the features that

the third medical image receiving system includes an in-hospital terminal, and

the image relay server includes a fourth medical image data transmission device configured to transmit the medical image data to the in-hospital terminal based on an image relay form having relay information on a transmission destination of the medical image data and image identification information for identifying the medical image data in response to a request from the in-hospital terminal, or

a third medical image receiving system in a seventh and eighth medical image exchange systems.

A tenth medical image exchange system is a medical image exchange system for allowing a plurality of medical institutions to exchange medical image data between the medical institutions, the system being configured to communicatably connect (A) medical image transmission system to a medical image receiving system of any of (B-1) to (B-5) described below, where the medical image transmission system is the first medical image transmission system in the first, third and seventh medical image exchange systems or the second medical image transmission system in the second, fourth and eighth medical image exchange systems, to exchange medical image data between a plurality of medical institutions, wherein

the medical image display terminal in the medical image transmission system includes:
medical image data including patient identification information unique to a medical institution using the medical image transmission system,

the medical image transmission system further includes:
a first patient identification information database configured to associate the common patient identification information that is independent of a medical institution and the patient identification information unique to a medical institution, on a patient-by-patient basis and stores them; and
a first patient identification information conversion device configured to convert the unique patient identification information included in medical image data acquired by the medical image data acquisition device to the common patient identification information, based on the first patient identification information database,

the medical image receiving system further includes:
a second patient identification information database configured to associate the common patient identification information and patient identification information unique to a medical institution using the medical image receiving system on a patient-by-patient basis and stores them, and
a second patient identification information conversion device configured to convert the common patient identification information included in the medical image data received to the unique patient identification information, based on the second patient identification information database, wherein

(B-1) the medical image receiving system is a first medical image receiving system in a medical image exchange system configured to allow a plurality of medical institutions to exchange medical image data between the medical institutions through an image relay server, the system being configured to communicatably connect the image relay server to the one or a plurality of first medical image receiving systems used in each of the medical institutions, the medical image exchange system including the features that

the image relay server includes a transmission device configured to transmit the medical image data to the first medical image receiving system based on an image relay form having relay information on a transmission destination of the medical image data, and image identification information for identifying the medical image data,

the first medical image receiving system includes:
an in-hospital terminal;
a medical image display terminal;
a medical image database;
a medical image data receiving device configured to receive the medical image data; and
a medical image data storing device configured to store, in the medical image database, the medical image data received by the medical image data receiving device,

the image relay server further includes a transmission device configured to transmit the image relay form to the first medical image receiving system based on the image relay form, and

the first medical image receiving system further includes:
a third image relay form receiving device configured to receive the image relay form; and
a transmission device configured to transmit the medical image data in the medical image database to the medical image display terminal based on the image relay form received by the third image relay form receiving device in response to a request from the in-hospital terminal,

(B-2) the medical image receiving system is a first medical image receiving system in the fifth medical image exchange system,

(B-3) the medical image receiving system is a second medical image receiving system in a medical image exchange system configured to allow a plurality of medical institutions to exchange medical image data between the medical institutions through an image relay server, the system being configured to communicatably connect the image relay server to the one or a plurality of second medical image receiving systems used in each of the medical institutions, the medical image exchange system including the features that

the image relay server includes a medical image data transmission device configured to transmit the medical image data to the second medical image receiving system based on an image relay form having relay information on a transmission destination of the medical image data, and image identification information for identifying the medical image data,

the second medical image receiving system includes:
an in-hospital terminal;
a medical image display terminal;
a medical image database;
a medical image data receiving device configured to receive the medical image data; and
a medical image data storing device configured to store, in the medical image database, the medical image data received by the medical image data receiving device,

the image relay server further includes a transmission device configured to transmit a request to capture the medical image data to the second medical image receiving system based on the image relay form in response to a request from the in-hospital terminal, and

the second medical image receiving system further includes a third medical image data transmission device configured to transmit the medical image data in the medical image database to the medical image display terminal in response to the capture request,

(B-4) the medical image receiving system is a second medical image receiving system in the sixth medical image exchange system, and

(B-5) the medical image receiving system is a third medical image receiving system in a medical image exchange system configured to allow a plurality of medical institutions to exchange medical image data between the medical institutions through an image relay server, the system being configured to communicatably connect the image relay server to the one or a plurality of third medical image receiving systems used in each of the medical institutions, the medical image exchange system including the features that

the third medical image receiving system includes an in-hospital terminal, and

the image relay server includes a fourth medical image data transmission device configured to transmit the medical image data to the in-hospital terminal based on an image relay form having relay information on a transmission destination of the medical image data and image identification information for identifying the medical image data in response to a request from the in-hospital terminal, or

a third medical image receiving system in a seventh and eighth medical image exchange systems.

The first image relay server is an image relay server being the image relay server in the first to eighth medical image exchange systems.

The first medical image transmission system is a medical image transmission system, the system being the first medical image transmission system in the first, third and seventh medical image exchange systems, the second medical image transmission system in the second, fourth and eighth medical image exchange systems, or the ninth and tenth medical image transmission systems.

The first medical image receiving system is a medical image receiving system, the system being the first medical image receiving system in the fifth medical image exchange system, the second medical image receiving system in the sixth medical image exchange system, the third medical image receiving system in the seventh and eighth medical image exchange systems, or the medical image receiving system in the ninth and tenth medical image exchange systems.

The first relay server is a relay server configured to serve as the relay server in any one of the third to eighth medical image exchange system.

The first in-hospital information system is an in-hospital information system configured to serve as the in-hospital information system in any one of the third, fifth and seventh medical image exchange system.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A medical image exchange system for allowing a plurality of medical institutions to exchange medical image data between the medical institutions through an image relay server, the system being configured to communicatably connect the image relay server to one or a plurality of medical image transmission systems used in each of the medical institutions, the medical image exchange system comprising:
an in-hospital terminal;
a medical image display terminal;
a transmission destination input device configured to input a transmission destination of medical image data held by the medical image display terminal in response to a request from the in-hospital terminal;
a medical image data selection device configured to select any of the medical image data held by the medical image display terminal in response to a request from the in-hospital terminal; and
an image relay form generation device configured to generate an image relay form including relay information on the transmission destination input by the transmission destination input device, and image identification information for identifying the medical image data selected by the medical image data selection device, wherein
the image relay server includes a transmission device configured to transmit a request to acquire the medical image data to the medical image transmission system based on the image relay form,
the medical image transmission system includes:
a medical image data acquisition device configured to acquire the medical image data from the medical image display terminal in response to the acquisition request; and
a first medical image data transmission device configured to transmit to the image relay server the medical image data acquired by the medical image data acquisition device, and
the image relay server further includes:
a medical image database;
a medical image data receiving device configured to receive the medical image data; and
a medical image data storing device configured to store the medical image data received by the medical image data receiving device in the medical image database.

2. The medical image exchange system according to claim 1, wherein
the medical image transmission systems include a first medical image transmission system that includes:
the in-hospital terminal;
the medical image display terminal;
the transmission destination input device;
the medical image data selection device;
the image relay form generation device; and
a transmission device configured to transmit image relay form generated by the image relay form generation device to the image relay server, wherein
the image relay server includes a second image relay form receiving device configured to receive the image relay form, and
the transmission device transmits a request to acquire the medical image data transmits the request to acquire the medical image data to the first medical image transmission system based on the image relay form received by the second image relay form receiving device.

3. The medical image exchange system according to claim 2, wherein
the first medical image transmission system further includes a relay server and an in-hospital information system,
the transmission device configured to transmit the image relay form to the image relay server includes:
a first image relay form transmission device configured to transmit the image relay form generated by the image relay form generation device to the relay server;
a first image relay form receiving device configured to receive the image relay form; and
a second image relay form transmission device configured to transmit an image relay form received by the first image relay form receiving device to the image relay server,
the transmission device transmits the a request to acquire the medical image data including a first acquisition request transmission device configured to transmit a request to acquire the medical image data to the relay server based on the image relay form received by the second image relay form receiving device,
the in-hospital information system includes:
the transmission destination input device;
the medical image data selection device;
the image relay form generation device; and
a first image relay form transmission device, and
the relay server includes:
the first image relay form receiving device;
the second image relay form transmission device;
the medical image data acquisition device; and
the first medical image data transmission device.

4. The medical image exchange system according to claim 3, the system being further configured to communicatably connect to one or a plurality of third medical image receiving systems used in the medical institution, wherein
the third medical image receiving system includes an in-hospital terminal, and
the image relay server further includes a fourth medical image data transmission device configured to transmit medical image data from the medical image database to the in-hospital terminal based on an image relay form received by the second image relay form receiving device in response to a request from the in-hospital terminal.

5. The medical image exchange system according to claim 1, wherein
the medical image transmission systems include a second medical image transmission system that includes:
the in-hospital terminal; and
the medical image display terminal,
the image relay server includes:
the transmission destination input device;
the medical image data selection device; and
the image relay form generation device, and
the transmission device configured to transmit a request to acquire the medical image data transmits the request to acquire the medical image data to the second medical image transmission system based on the image relay form generated by the image relay form generation device.

6. The medical image exchange system according to claim 5, wherein
the second medical image transmission system further includes a relay server,
the transmission device configured to transmit a request to acquire the medical image data includes a second acquisition request transmission device configured to transmit a request to acquire the medical image data to the relay server based on the image relay form generated by the image relay form generation device, and
the relay server includes the first medical image data transmission device.

7. The medical image exchange system according to claim 6, the system being further configured to communicatably connect to one or a plurality of third medical image receiving systems used in a medical institution, wherein
the third medical image receiving system includes an in-hospital terminal, and
the image relay server further includes a fourth medical image data transmission device configured to transmit medical image data from the medical image database to the in-hospital terminal based on an image relay form generated by the image relay form generation device in response to a request from the in-hospital terminal.

8. A medical image exchange system for allowing a plurality of medical institutions to exchange medical image data between the medical institutions through an image relay server, the system being configured to communicatably connect the image relay server to the one or a plurality of medical image receiving systems used in each of the medical institutions, wherein
the image relay server includes a medical image data transmission device configured to transmit the medical image data to medical image receiving system based on an image relay form including relay information on a transmission destination of the medical image data and image identification information for identifying the medical image data,
the medical image receiving system includes:
a medical image display terminal;
a medical image database;
a medical image data receiving device configured to receive the medical image data; and
a medical image data storing device configured to store the medical image data received by the medical image data receiving device in the medical image database, and
the transmission device transmits the medical image data from the medical image database to the medical image display terminal based on the medical image relay form.

9. The medical image exchange system according to claim 8, wherein
the medical image receiving systems include a first medical image receiving system that includes:
an in-hospital terminal;
a relay server;
a medical image display terminal; and
the in-hospital information system,
the transmission device configured to transmit the medical image data to medical image receiving system includes a second medical image data transmission device configured to transmit the medical image data to the relay server based on an image relay form,
the transmission device configured to transmit the medical image data in the medical image database includes:
a third image relay form transmission device configured to transmit the image relay form to the relay server based on the image relay form;
a third image relay form receiving device configured to receive the image relay form;
an image relay form acquisition device configured to acquire the image relay form from the relay server based on in response to the capture request;
a first capture request transmission device configured to transmit a request to capture the medical image data to the relay server based on the image relay form acquired by the image relay form acquisition device in response to a request from the in-hospital terminal; and
a third medical image data transmission device configured to transmit the medical image data in the medical image database to the medical image display terminal in response to a request from the in-hospital terminal, and
the image relay server includes:
the second medical image data transmission device; and
the third image relay form transmission device,
the in-hospital information system includes:
the image relay form acquisition device; and
the first capture request transmission device, and
the relay server includes:
the medical image database;
the medical image data receiving device;
the medical image data storing device;
the third image relay form receiving device; and
the third medical image data transmission device.

10. The medical image exchange system according to claim 8, wherein
the second medical image receiving system includes:
an in-hospital terminal;
a relay server; and
the medical image display terminal,
the transmission device configured to transmit the medical image data to medical image receiving system includes second medical image data transmission device configured to transmit the medical image data to the relay server based on an image relay form,
the transmission device configured to transmit the medical image data in the medical image database includes:
a second capture request transmission device configured to transmit a request to capture the medical image data to the relay server based on the image relay form in response to a request from the in-hospital terminal; and
a third medical image data transmission device configured to transmit the medical image data in the medical image database to the medical image display terminal in response to the capture request; and
the image relay server includes:
the second medical image data transmission device; and
the second capture request transmission device, and
the relay server includes:
the medical image database;
the medical image data receiving device;
the medical image data storing device; and
the third medical image data transmission device.

11. A medical image exchange system for allowing a plurality of medical institutions to exchange medical image data between the medical institutions, the system being configured to communicatably connect (A) a medical image transmission system according to claim 1 to a medical image receiving system of any of (B-1) to (B-4) described below, wherein
the medical image transmission system further includes a transmission purpose input device configured to input the purpose of transmitting the medical image data,
the image relay form generation device generates an image relay form including the transmission purpose input by the transmission purpose input device, and
the medical image receiving system further includes a medical image display device configured to display medical image based on the transmission purpose included in the image relay form, wherein
(B-1) the medical image receiving system is a first medical image receiving system in a medical image exchange system configured to allow a plurality of medical institutions to exchange medical image data between the medical institutions through an image relay server, the system being configured to communicatably connect the image relay server to the one or a plurality of first medical image receiving systems used in each of the medical institutions, wherein
the image relay server includes a transmission device configured to transmit the medical image data to the first medical image receiving system based on an image relay form having relay information on a transmission destination of the medical image data, and image identification information for identifying the medical image data,
the first medical image receiving system includes:
an in-hospital terminal;
a medical image display terminal;
a medical image database;
a medical image data receiving device configured to receive the medical image data; and
a medical image data storing device configured to store, in the medical image database, the medical image data received by the medical image data receiving device,
the image relay server further includes a transmission device configured to transmit the image relay form to the first medical image receiving system based on the image relay form, and
the first medical image receiving system further includes:
a third image relay form receiving device configured to receive the image relay form; and
a transmission device configured to transmit the medical image data in the medical image database to the medical image display terminal based on the image relay form received by the third image relay form receiving device in response to a request from the in-hospital terminal,
(B-2) the medical image receiving system is a medical image receiving system in a medical image exchange system configured to allow a plurality of medical institutions to exchange medical image data between the medical institutions through an image relay server, the system being configured to communicatably connect the image relay server to one or a plurality of medical image receiving systems used in each of the medical institutions, wherein
the image relay server includes a transmission device configured to transmit the medical image data to the medical image receiving system based on an image relay form having relay information on a transmission destination of the medical image data, and image identification information for identifying the medical image data,
the medical image receiving system includes:
a medical image display terminal;
a medical image database;
a medical image data receiving device configured to receive the medical image data;
a medical image data storing device configured to store the medical image data received by the medical image data receiving device in the medical image database; and
the medical image exchange system includes a transmission device configured to transmit the medical image data in the medical image database to the medical image display terminal based on the image relay form,
(B-3) the medical image receiving system is a second medical image receiving system in a medical image exchange system configured to allow a plurality of medical institutions to exchange medical image data between the medical institutions through an image relay server, the system being configured to communicatably connect the image relay server to the one or a plurality of second medical image receiving systems used in each of the medical institutions, wherein
the image relay server includes transmission device configured to transmit the medical image data to the second medical image receiving system based on an image relay form having relay information on a transmission destination of the medical image data, and image identification information for identifying the medical image data,
the second medical image receiving system includes:
an in-hospital terminal;
a medical image display terminal;
a medical image database;
a medical image data receiving device configured to receive the medical image data; and
a medical image data storing device configured to store, in the medical image database, the medical image data received by the medical image data receiving device,
the image relay server further includes a transmission device configured to transmit a request to capture the medical image data to the second medical image receiving system based on the image relay form in response to a request from the in-hospital terminal, and
the second medical image receiving system further includes a third medical image data transmission device configured to transmit the medical image data in the medical image database to the medical image display terminal in response to the capture request, and
(B-4) the medical image receiving system is a third medical image receiving system in a medical image exchange system configured to allow a plurality of medical institutions to exchange medical image data between the medical institutions through an image relay server, the system being configured to communicatably connect the image relay server to the one or a plurality of third medical image receiving systems used in each of the medical institutions, wherein
the third medical image receiving system includes an in-hospital terminal, and
the image relay server includes a fourth medical image data transmission device configured to transmit the medical image data to the in-hospital terminal based on an image relay form having relay information on a transmission destination of the medical image data and image identification information for identifying the medical image data in response to a request from the in-hospital terminal.

12. A medical image exchange system for allowing a plurality of medical institutions to exchange medical image data between the medical institutions, the system being configured to communicatably connect (A) a medical image transmission system according to claim 1 to a medical image receiving system of any of (B-1) to (B-4) described below, wherein
the medical image display terminal in the medical image transmission system includes medical image data including patient identification information unique to a medical institution using the medical image transmission system,
the medical image transmission system further includes:
a first patient identification information database configured to associate the common patient identification information that is independent of a medical institution and the unique patient identification information, on a patient-by-patient basis and stores them; and
a first patient identification information conversion device configured to convert the unique patient identification information included in medical image data acquired by the medical image data acquisition device to the common patient identification information, based on the first patient identification information database,
the medical image receiving system further includes:
a second patient identification information database configured to associate the common patient identification information and patient identification information unique to a medical institution using the medical image receiving system on a patient-by-patient basis and stores them, and
a second patient identification information conversion device configured to convert the common patient identification information included in the medical image data received to the unique patient identification information, based on the second patient identification information database, wherein
(B-1) the medical image receiving system is a first medical image receiving system in a medical image exchange system configured to allow a plurality of medical institutions to exchange medical image data between the medical institutions through an image relay server, the system being configured to communicatably connect the image relay server to the one or a plurality of first medical image receiving systems used in each of the medical institutions, wherein
the image relay server includes transmission device configured to transmit the medical image data to the first medical image receiving system based on an image relay form having relay information on a transmission destination of the medical image data, and image identification information for identifying the medical image data,
the first medical image receiving system includes:
an in-hospital terminal;
a medical image display terminal;
a medical image database;
a medical image data receiving device configured to receive the medical image data; and
a medical image data storing device configured to store, in the medical image database, the medical image data received by the medical image data receiving device,
the image relay server further includes a transmission device configured to transmit the image relay form to the first medical image receiving system based on the image relay form, and
the first medical image receiving system further includes:
a third image relay form receiving device configured to receive the image relay form; and
a transmission device configured to transmit the medical image data in the medical image database to the medical image display terminal based on the image relay form received by the third image relay form receiving device in response to a request from the in-hospital terminal,
(B-2) the medical image receiving system is a medical image receiving system in a medical image exchange system configured to allow a plurality of medical institutions to exchange medical image data between the medical institutions through an image relay server, the system being configured to communicatably connect the image relay server to the one or a plurality of medical image receiving systems used in each of the medical institutions, wherein
the image relay server includes a transmission device configured to transmit the medical image data to medical image receiving system based on an image relay form including relay information on a transmission destination of the medical image data and image identification information for identifying the medical image data,
the medical image receiving system includes:
an in-hospital terminal;
a medical image database;
a medical image data receiving device configured to receive the medical image data;
a medical image data storing device configured to store the medical image data received by the medical image data receiving device in the medical image database, and
the medical image exchange system includes a transmission device configured to transmit the medical image data in the medical image database to the medical image display terminal based on the image relay form,
(B-3) the medical image receiving system is a second medical image receiving system in a medical image exchange system configured to allow a plurality of medical institutions to exchange medical image data between the medical institutions through an image relay server, the system being configured to communicatable connect the image relay server to the one or a plurality of second medical image receiving systems used in each of the medical institutions, wherein
the image relay server includes a transmission device configured to transmit the medical image data to the second medical image receiving system based on an image relay form having relay information on a transmission destination of the medical image data, and image identification information for identifying the medical image data,
the second medical image receiving system includes:
an in-hospital terminal;
a medical image display terminal;
a medical image database;
a medical image data receiving device configured to receive the medical image data; and
a medical image data storing device configured to store, in the medical image database, the medical image data received by the medical image data receiving device,
the image relay server further includes a transmission device configured to transmit a request to capture the medical image data to the second medical image receiving system based on the image relay form in response to a request from the in-hospital terminal, and
the second medical image receiving system further includes a third medical image data transmission device configured to transmit the medical image data in the medical image database to the medical image display terminal in response to the capture request,
(B-4) the medical image receiving system is a third medical image receiving system in a medical image exchange system configured to allow a plurality of medical institutions to exchange medical image data between the medical institutions through an image relay server, the system being configured to communicatably connect the image relay server to the one or a plurality of third medical image receiving systems used in each of the medical institutions, wherein
the third medical image receiving system includes an in-hospital terminal, and
the image relay server includes a fourth medical image data transmission device configured to transmit the medical image data to the in-hospital terminal based on an image relay form having relay information on a transmission destination of the medical image data and image identification information for identifying the medical image data in response to a request from the in-hospital terminal.

13. An image relay server configured to serve as the image relay server in the medical image exchange system according to claim 1.

14. A medical image transmission system configured to serve as the medical image transmission system in the medical image exchange system according to claim 1.

15. A medical image receiving system configured to serve as the medical image receiving system in the medical image exchange system according to claim 8.

16. A relay server configured to serve as the relay server in the medical image exchange system according to claim 3.

17. An in-hospital information system configured to serve as the in-hospital information system in the medical image exchange system according to claim 3.

18. An in-hospital information system configured to serve as the in-hospital information system in the medical image exchange system according to claim 9.
